(19) United States
(12) Patent Application Publication
(10) Pub. No.: US 2026/0201913 A1
(43) Pub. Date: Jul. 16, 2026

(54) Hydraulic Device with a Status Display

(71) Applicant: Robert Bosch GmbH, Stuttgart (DE)

(72) Inventors: Jochen Gessner, Rodenbach (DE); Sebastian Herbst, Kleinrinderfeld (DE); Jan Willems, Esselbach (DE); Christoph Heller, Marktheidenfeld (DE)

(21) Appl. No.: 18/867,766

(22) PCT Filed: May 17, 2023
(86) PCT No.: PCT/EP2023/063231

§ 371 Date: Nov. 20, 2024

(30) Foreign Application Priority Data
May 25, 2022 (DE) 10 2022 205 289.7

(51) Int. Cl. F15B 19/00

(52) U.S. Cl. CPC F15B 19/00

(57) ABSTRACT

A hydraulic device includes a hydraulic unit, an electronic unit, and an interface. The electronic unit is designed to acquire, during operation of the hydraulic unit, measured values, to derive at least one individual indicator from the measured values, and to determine an overall indicator from the at least one individual indicator and to output the overall indicator at the interface.

The present invention relates to a hydraulic device with a hydraulic unit, an electronic unit and an interface, a method for outputting an overall indicator for such a hydraulic device, as well as an electronic unit and a computer program for its implementation.

### BACKGROUND OF THE INVENTION

Hydraulic devices such as valves or hydraulic machines (pump, motor) are becoming increasingly electronic or digitalized. In addition to control, digitalization can also bring advantages for monitoring, especially for recording measured values.

### DISCLOSURE OF THE INVENTION

The invention proposes a hydraulic device with a hydraulic unit, an electronic unit and an interface, a method for outputting an overall indicator for such a hydraulic device, as well as an electronic unit and a computer program for implementing it with the features of the independent claims. Advantageous embodiments are the subject of the dependent claims and the following description.

The invention makes it possible to determine and output a device state autonomously in the device, independently of external systems. In particular, the device state (“device health”) can be provided and visualized in the form of the overall indicator and/or in the form of individual indicators. The output can be wired or wireless, and likewise connection-oriented or connectionless.

The invention extends the diagnostic function to include detection and display of the device status with the aim of detecting and indicating impending failures or operation outside the specification.

The invention makes use of a local or device-side recording of internal device data to determine the device status, wherein at least one, in particular multiple, individual indicators are formed from the recorded data, wherein in turn the overall indicator is determined or derived from the at least one individual indicator.

In one embodiment, the overall indicator can be output on a display unit of the hydraulic device, e.g. a display, illuminant, LED display, etc. This is a particularly simple yet easily recognizable form of output. In one embodiment, the overall indicator can classify the device status and, for example, comprise three classes, e.g. “good”, “medium” or “moderate”, “poor” or “critical”. In particular, these can be visualized very well using traffic light colors, with the colors green (“good”), yellow (“moderate”) and red (“critical”).

In one embodiment, the overall indicator can be output at a wired or wireless interface of the hydraulic device, e.g. an IO-Link interface or Bluetooth interface. The overall indicator can be provided via connectionless communication (e.g. BLE (Bluetooth low energy) advertisement). Alternatively or additionally, the overall indicator can be provided via connection-oriented communication (e.g. BLE point-to-point).

In one embodiment, the at least one individual indicator can be provided via connection-oriented communication (e.g. BLE point-to-point).

Suitable hydraulic devices are all hydraulic devices with an electronic unit (computing unit), in particular valves, hydraulic machines (pumps or motors) and hydraulic cylinders, which can be equipped with easily understandable status monitoring and visualization by the invention.

An electronic unit of a hydraulic device according to the invention is set up, in particular in terms of programming, to carry out a method according to the invention.

The implementation of a method according to the invention in the form of a computer program or computer program product with program code for carrying out all method steps, in particular in the form of a so-called firmware of the hydraulic device, is also advantageous, as this causes particularly low costs, since the executing electronic unit is still used for other tasks and is therefore available anyway. Suitable data carriers for providing the computer program are, in particular, magnetic, optical, and electric storage media, such as hard disks, flash memory, EEPROMs, DVDs, and others. Downloading a program via computer networks (internet, intranet, etc.) is also possible.

Further advantages and embodiments of the invention will emerge from the description and the accompanying drawings.

It is understood that the features specified hereinabove and those to be explained hereinafter can be used not only in the combination indicated in each case, but also in other combinations or on their own, without departing from the scope of the present invention.

The invention is thoroughly illustrated schematically in the drawings on the basis of exemplary embodiments and is described hereinafter with reference to the drawings.

### DESCRIPTION OF THE DRAWINGS

FIG. 1 illustrates an exemplary hydraulic device according to one embodiment of the invention.

FIG. 2 schematically illustrates the generation of an overall indicator from a number of individual indicators according to one embodiment of the invention.

FIG. 3 schematically illustrates the generation of a single indicator based on a supply voltage according to one embodiment of the invention.

FIG. 4 schematically illustrates an example of the formation of a single indicator according to one embodiment of the invention.

FIG. 5 schematically illustrates the interaction of different units for outputting individual indicators and/or the overall indicator according to one embodiment of the invention.

### DETAILED DESCRIPTION OF THE DRAWINGS

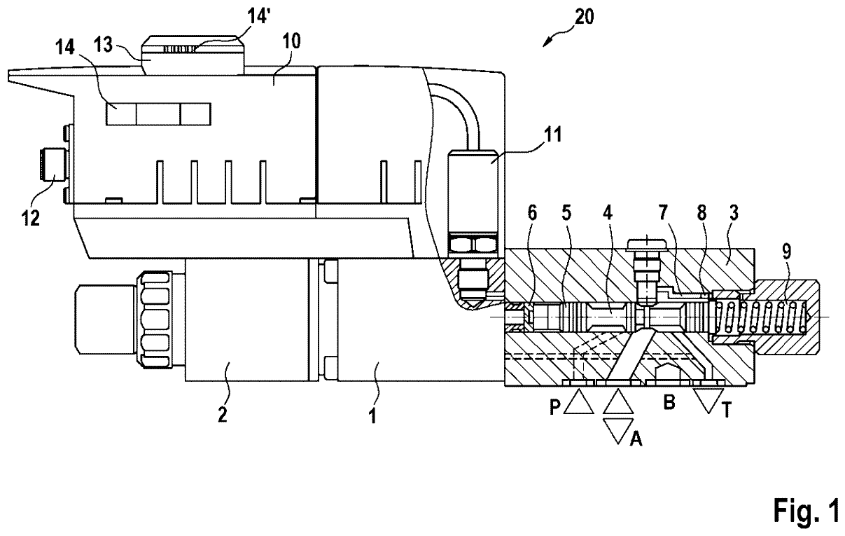

In FIG. 1, a hydraulic device designed as a valve is schematically illustrated in a partially sectioned side view and labeled 20. For example, this is an electrically pilot-controlled 3-way pressure reducing valve with pressure protection for the consumer. Such valves can be used in particular to reduce a system pressure.

In the embodiment shown, the valve has a pilot valve 1, a proportional solenoid 2 and a main valve 3 with main control slider 4. As usual, the main valve is equipped with connections for P, A, B and T. In the rest position, i.e. without pressure in channel P, a spring 9 holds the main control slider 4 in its initial position (far right in the figure). This opens the connection from A to T and blocks the connection from P to A.

Hydraulic fluid, such as pilot oil, flows through a pressure connection from port P via a flow regulator 5, a nozzle and a throttle gap to pilot valve 1 and then flows out to channel T. The proportional solenoid 2 is used to set the pressure to be reduced in channel A depending on the target value. The pilot pressure builds up in a control chamber 6 as a function of the target value. This shifts the main control slider 4 to the right, causing pressurized fluid to flow from P to A. The consumer pressure in channel A is applied via a channel 7 and a nozzle 8 in the spring chamber 9. If the pressure in port A rises to the set pressure of the pilot valve, this causes the main control slider 4 to move to the left. The pressure in port A is approximately the same as the pressure set on the pilot valve.

However, if the pressure in port A exceeds the set pressure of the pilot valve, the main control slider 4 is moved further to the left so that the connection from A to T opens. This limits the pressure in port A to the set target value.

A computing unit or electronic unit 10 is located on the proportional solenoid 2. This can be equipped with various electrical interfaces 12, such as an analog interface (e.g. current or voltage interface for receiving a target value) and/or a digital interface, such as 10-Link, for receiving and transmitting data (target value, actual value, etc.). In this example, a pressure transducer 11 is also fitted directly on the pilot valve, but can also be integrated externally in the system via an interface 12. The pressure in channel P is measured by the pressure transducer 11 and controlled independently of the volumetric flow by the electronic unit 10. The pressure in channel A can be made available as an analog or digital actual value. At target value zero, the electronic unit 10 only applies a minimum control current to the proportional solenoid 2 and a minimum set pressure is set.

In the embodiment shown, the electronic unit 10 also has wireless interfaces, for example a Bluetooth interface or a Bluetooth dongle 13 (e.g. in accordance with “Bluetooth Low Energy”). In particular, this can be used to provide a digital diagnostic interface, which can be used to display the status of the valve externally and to configure the valve.

Furthermore, the electronic unit 10 has a display unit 14, here for example in the form of three illuminated displays, e.g. LEDs, with which a status of the valve 20 can be displayed in a simple manner, for example textually, symbolically, in color, by different flashing frequencies and the like. Alternatively or additionally, the Bluetooth dongle 13 can also have a display unit 14′, here for example in the form of illuminated displays, e.g. LEDs. Displays or similar can also be used.

Signals are collected within a hydraulic device, such as the valve 20 in FIG. 1, from which any number of status indicators can be generated directly or by combining signals and other data as individual indicators 201, 202, 203, . . . can be generated. These individual indicators may differ depending on the device version and valve family. An example of an individual indicator is shown and explained in FIG. 3.

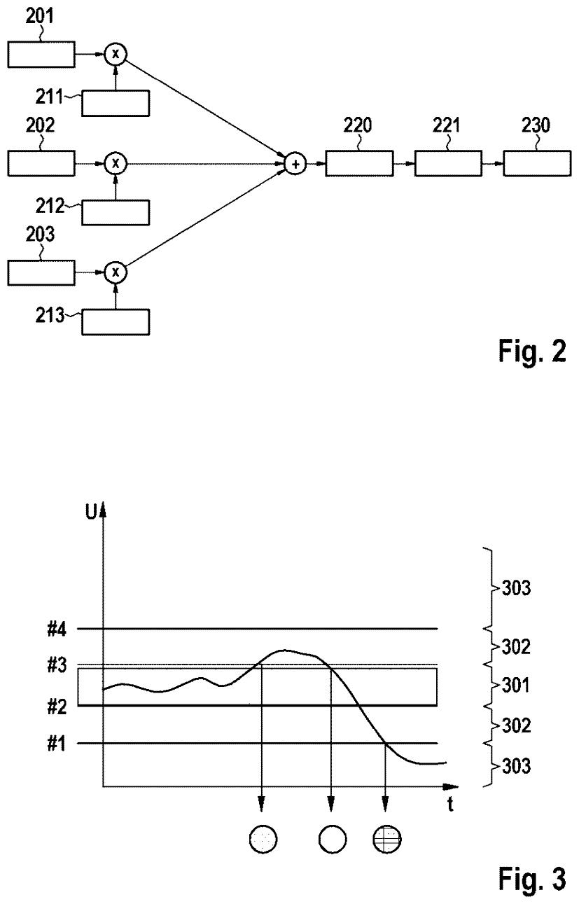

An overall indicator 230 is determined from the available individual status indicators using evaluation criteria, as explained below with reference to FIG. 2, for example. To form the overall indicator 230, the available individual indicators 201, 202, 203, . . . each with a specific weighting factor 211,212, 213, . . . and the results can be summarized (especially additively) to obtain an overall indicator raw value 220, which serves as the basis for the formation of the overall indicator 230. Based on configuration data (evaluation criteria) 221, the final state of the overall indicator 230 is formed from this value. For example, the calculated overall indicator raw value is converted into the categories “good”, “moderate” or “critical” on the basis of limit values or ranges. For example, a value of >1000 can mean “critical”, a value of <100 “good” and values in between “moderate”.

As shown in FIG. 5, the overall indicator can be visualized directly on the device, e.g. by means of a traffic light function with the colors green (“good”), yellow (“moderate”) and red (“critical”) using the display unit 14 or 14′. Alternatively or additionally, the overall indicator can be transmitted to external devices, such as computers or mobile devices. This can be done connectionless (broadcasting), e.g. via BLE advertisement, or connection-oriented (e.g. via a BLE point-to-point connection), using the interface 12 and/or the Bluetooth dongle 13.

The individual indicators can also be transferred. They enable a more detailed display of the composition of the overall indicator and the “health status” of the valve. The data can be received and visualized by a suitable end device, e.g. in the form of a dashboard (graphical user interface; arrangement of various graphical elements used to visualize data or manage systems) in a smartphone app. In the end device, the display can be enriched and expanded with further (external and internal) data (e.g. by entering or recording further environmental conditions or additional data from the cloud). The end device can also act as a gateway and, for example, forward the determined “condition monitoring” data to various cloud services for storage or further processing.

Signals and individual indicators can also be used to generate further individual indicators with the help of model calculations. The indicators are determined autonomously in the valve, independently of (external) systems (e.g. cloud-based cloud systems). In addition, forwarding and further processing in external systems is possible.

In particular, very complex individual indicators and statements on the health status of the device can be generated, from compliance with the device specification and service life models to complex models on wear and the service life of the hydraulic and mechanical components of the overall system (e.g. valve, pump). By increasing the number and complexity of individual indicators, more meaningful overall indicators can be generated.

Simple solutions include counters and signal-based or measured value-based displays, which can essentially be used for monitoring. Typical examples are the counting of switching operations and the measurement of temperature curves, etc. In particular, threshold value comparisons can be made here to determine an indicator.

Slightly more complex solutions include simple lifetime models that work on a time-based or usage-based basis, for example. Typical examples are so-called MTBF values (mean time between failures), especially for electronics, and the counting of write operations for flash memory. Threshold value comparisons can also be made here in particular to determine an indicator.

Even more complex solutions include more elaborate service life models that take several variables into account simultaneously, for example. Typical examples are methods for determining material fatigue or valve dysfunction.

FIG. 3 shows an embodiment for generating an indicator based on the supply voltage. A supply voltage U of the valve is plotted against the time t. In particular, the underlying signal can be a voltage value of the supply voltage measured cyclically via an analog-to-digital converter. The signal can be filtered via a low-pass filter before evaluation.

As an example, four threshold values #1- #4 are defined as evaluation criteria, from which a subdivision of the signal range into five evaluation bands can be derived. The range between #2 and #3 is the signal range that is evaluated as normal operating range 301. The range between #1 and #2 or between #3 and #4 is the signal range that is considered the limit range 302 for operation and can be an initial indication that the device is being operated close to the limit of the device specification. Experience has shown that this has an unfavorable effect on device service life and reliability. The range below #1 or above #4 is a critical operating range 303 in which the device should not be operated.

According to one exemplary embodiment, these operating ranges are mapped onto an individual indicator such that operating range 301 corresponds to a value of “good”, operating range 302 corresponds to a value of “moderate” and operating range 303 corresponds to a value of “critical”. This is included in the formation of the overall indicator, which can then be visualized on a display of the valve (e.g. 14, 14′), e.g. in color using a traffic light function with the colors green, yellow and red. In addition, the individual indicator can be transmitted digitally and visualized on a dashboard or a general display, for example.

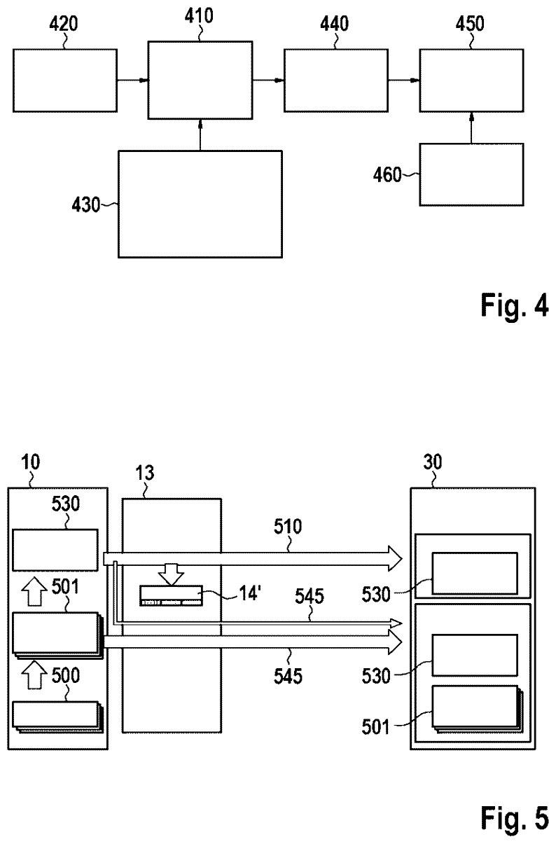

FIG. 4 schematically illustrates an example of the formation of a single indicator in a block diagram, which is based here on a model calculation.

Input variables 420 and, if necessary, configuration data 430 are fed to a model 410, from which a model result 440 is calculated. This can be filtered and converted if necessary (block 440) and fed to a block 450 to form the individual indicator together with optional further configuration data 460.

The input variables 420 include, in particular, count and/or measured values, for example in the form of signal curves, histograms, counter values, etc. Suitable measured variables are in particular temperatures, electrical voltages, electrical currents.

The configuration data 430 includes, for example, electronics-specific adaptation parameters, which may depend in particular on the components used (temperature resistance dielectric strength, etc., e.g. of capacitors, etc.), as well as conversion factors for measured values, histograms, etc.

In particular, the configuration data 460 may include evaluation criteria to calculate the individual indicator from the model result 440. The individual indicator can then be used to determine an overall indicator, as shown in FIG. 2, for example.

FIG. 5 schematically shows the interaction of individual units to output the overall indicator according to one embodiment of the invention in a block diagram.

In particular, measurement and counter values 500 are recorded in the electronic unit 10 of a hydraulic valve shown in FIG. 1 and calculated to form individual indicators 501, from which an overall indicator 530 is determined, as shown in particular in FIG. 2.

Both the individual indicators 501 and the overall indicator 530 can be transmitted using the Bluetooth dongle 13 to an external device 30, for example a tablet PC, a cell phone, a remote server or PC, etc., on which suitable software is running. The transfer can take place in a so-called connectionless type 540 or a connection-oriented type 545. In particular, the upper arrow 540 visualizes the connectionless transmission of the overall indicator, and the lower two arrows 545 show the connection-oriented transmission of the individual and overall indicator.

The overall indicator 530 can be visualized on the external device 30, e.g. in a device overview. Furthermore, the overall indicator 530 and the individual indicators 501 can be displayed in a setting program.

Alternatively or additionally, the overall indicator 530 can be visualized on the display 14, 14′, here for example by different colors. This is a particularly simple yet easily recognizable form of output, with which a user can be directly informed about the overall status of the device.

1. A hydraulic device comprising:
a hydraulic unit;
an interface; and
an electronic unit configured to acquire measured values during operation of the hydraulic unit, to derive at least one individual indicator from the measured values and determine an overall indicator from the at least one individual indicator, and to output the overall indicator at the interface.

2. The hydraulic device according to claim 1, wherein the electronic unit is further configured to output the at least one individual indicator at the interface.

3. The hydraulic device according to claim 1, wherein the interface comprises a visual display, and the outputting of the overall indicator at the interface comprises displaying the overall indicator on the visual display.

4. The hydraulic device according to claim 3, wherein the visual display has a screen and/or illuminant.

5. The hydraulic device according to claim 1, wherein the interface comprises a wired or a wireless interface, and the outputting of the overall indicator at the interface comprises a transmission to a further device.

6. The hydraulic device according to claim 5, wherein the interface comprises a Bluetooth interface.

7. A method for outputting an overall indicator for a hydraulic device having a hydraulic unit, an interface, and an electronic unit, the method comprising:
recording, with the electronic unit, measured values during operation of the hydraulic unit;
deriving, with the electronic unit, at least one individual indicator from the measured values;
determining, with the electronic unit, the overall indicator from the at least one individual indicator; and
outputting the overall indicator at the interface.

8. The method according to claim 7, wherein the overall indicator classifies an overall condition of the hydraulic device.

9. The method according to claim 8, wherein the overall indicator comprises three different classes.

10. An electronic unit of a hydraulic device that has a hydraulic unit and an interface, the electronic unit comprising:
a processor configured to:
record measured values during operation of the hydraulic unit;
deriving, with the electronic unit, at least one individual indicator from the measured values;
determining, with the electronic unit, an overall indicator from the at least one individual indicator; and
outputting the overall indicator at the interface.

11. A computer program comprising commands which, when the program is executed by a computer, prompt the computer to perform the method according to claim 7.

12. A non-transitory computer-readable data carrier comprising:
the computer program according to claim 11.
